(19) United States
(12) Patent Application Publication
(10) Pub. No.: US 2026/0181450 A1
(43) Pub. Date: Jun. 25, 2026

(54) METHODS, DEVICES AND MEDIUM FOR COMMUNICATION

(71) Applicant: NEC Corporation, Tokyo (JP)

(72) Inventors: Gang WANG, Beijing (CN); Peng GUAN, Beijing (CN)

(73) Assignee: NEC Corporation, Tokyo (JP)

(21) Appl. No.: 19/126,798

(22) PCT Filed: Nov. 4, 2022
(86) PCT No.: PCT/CN2022/129912

§ 371 Date: May 2, 2025

(51) Int. Cl. H04W 24/10; H04W 72/542

(52) U.S. Cl. CPC H04W 24/10; H04W 72/542

(57) ABSTRACT

Example embodiments of the present disclosure relate to a communication method. The method comprises determining, at a terminal device, first beam quality information based on a set of beam qualities of a set of beams; determining second beam quality information based on the first beam quality information and angle information associated with the terminal device; and transmitting, to a network device, a report that at least comprises the second beam quality information.

### FIELDS

Example embodiments of the present disclosure generally relate to the field of communication techniques and in particular, to methods, devices, and medium for reporting angle information.

### BACKGROUND

Several technologies have been proposed to improve communication performances. For example, beam management procedure is used in 5-th generation (5G) new radio (NR) in order to acquire and maintain a set of transmission reception points (TRxPs) and/or user equipment (UE) beams which can be used for downlink (DL) and uplink (UL) transmission/reception. In this situation, UE needs to provide information to a network for the beam management. Therefore, which information to be provided is critical for the beam management.

### SUMMARY

In general, embodiments of the present disclosure provide methods, devices and computer storage medium for reporting angle information.

In a first aspect, there is provided a communication method. The method comprises: determining, at a terminal device, first beam quality information based on a set of beam qualities of a set of beams; determining second beam quality information based on the first beam quality information and angle information associated with the terminal device; and transmitting, to a network device, a report that at least comprises the second beam quality information.

In a second aspect, there is provided a communication method. The method comprises: receiving, at a network device and from a terminal device, a report that at least comprises second beam quality information, wherein the second beam quality information is determined based on first beam quality information and angle information associated with the terminal device, and wherein the first beam quality information is determined based on a set of beam qualities of a set of beams.

In a third aspect, there is provided a terminal device. The terminal device comprises at least one processor; and at least one memory coupled to the at least one processor and storing instructions thereon, the instructions, when executed by the at least one processor, causing the terminal device to perform the method according to the first aspect.

In a fourth aspect, there is provided a network device. The network device comprises at least one processor; and at least one memory coupled to the at least one processor and storing instructions thereon, the instructions, when executed by the at least one processor, causing the network device to perform the method according to the second aspect.

In a fifth aspect, there is provided a computer readable medium having instructions stored thereon, the instructions, when executed on at least one processor, causing the at least one processor to carry out the method according to the first, or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a signaling flow of reporting angle information in accordance with some embodiments of the present disclosure;

FIG. 3 illustrates a schematic diagram of angle information;

FIG. 4 illustrates a schematic diagram of downlink control information (DCI) in accordance with some embodiments of the present disclosure;

FIG. 5 illustrates a schematic diagram of downlink control information (DCI) in accordance with some other embodiments of the present disclosure;

FIG. 6 illustrates a flowchart of a method implemented at a terminal device according to some example embodiments of the present disclosure;

FIG. 7 illustrates a flowchart of a method implemented at a network device according to some example embodiments of the present disclosure; and

FIG. 8 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As mentioned above, which information to be provided is critical for the beam management. In some solutions, the UE may be configured with a beam report by gNB. The beam report may correspond to one or more sets of reference signal resources by radio resource control (RRC) signaling. Assuming one reference signal resource set is configured for the beam report, and the set of reference signal resource can be regarded as Set A. The beam report may be configured with a higher layer parameter (i.e., nrofReportedRS, it can be called as K) by RRC signaling. K refers to the number of beam that UE needs to report, e.g., top K beams out of the beams in Set A. UE needs to calculate the layer 1 reference signal received power (L1-RSRP) corresponding to all beams in Set A and select top K beams (i.e., having the largest L1-RSRP) to as the beams to report. UE transmits to gNB the generated beam report in allocated PUCCH/PUSCH resources.

For beam management cases, it has been agreed to study using L1-RSRP measurement and angle information at UE side as input of artificial intelligence/machine learning (AI/ML) model. From the evaluation results, the angle information at UE side can enhance the performance (i.e., beam prediction accuracy) of model inference. Meanwhile, the angle information at UE side can enhance the generalization performance of AI/ML model, e.g., the trained AI/ML model can be applicable to different UEs with various beam configurations (e.g., number of beams, beam angle) or from various directions related to gNB. Furthermore, compared with beam ID at UE side (e.g., Rx beam ID, Tx Rx beam pair ID) as AI/ML input, the angle information (e.g., Rx beam angle) can bring higher inference performance and generalization performance. For example, the trained AI/ML model is based on (or coupled with) a particular and designed UE with a specific beam configuration. But in fact, different UEs have different beam configurations. Accordingly, the beam ID in model inference is difficult to align (or match) with the beam ID in model training, which will increase the difficulty of model inference.

Considering that the RSRP and the angle information need to be as AI/ML input at the same time and the RSRP is reported by using a beam report, it looks likely to be a natural solution that the angle information can be introduced into the beam report. However, it may have some difficulties. For example, due to the wide range (e.g., −180°˜180°) of the angle information, it is a problem how to quantize the angle information, e.g., determination of quantization step size. For example, if the quantization step size is set too low, it may cause additional unnecessary overhead. If the quantization step size is set too high, it may cause strong correlation between different angles (i.e., features), thus affecting the performance of model inference. Different UE have different beam/antenna/panel configurations, the corresponding range of the angle information may be different. Moreover, it may involve a lot of radio access network (RAN) 4 works.

In order to solve at least part of the above problems, embodiments of the present disclosure provide a solution for reporting angle information. A terminal device determines first beam quality information based on a set of beam qualities of a set of beams. The terminal device also determines second beam quality information based on the first beam quality information and angle information associated with the terminal device. The terminal device transmits a report that at least comprises the second beam quality information to a network device. In this way, the angle information and beam quality information can be provided to the network device, thereby improving beam management performances.

In the context of the presented application, the term “beam” may be interchangeably with “reference signal resource.” For example, the beam may correspond to a channel state information reference signal (CSI-RS) resource or CSI-RS resource set. Alternatively, the beam may correspond to a Synchronization Signal and Physical Broadcast Channel (PBCH) block (SSB) resource or SSB resource set. The term “beam quality” may be interchangeably with “reference signal quality.” For example, the beam quality may refer to one or more of: a RSRP, a L1-RSRP, a signal to interference plus noise ratio (SINR), or a L1-SINR. The term “beam of a signal” may be interchangeably with “Quasi-co location (QCL)-TypeD RS of the signal.” The term “QCL-TypeD” may refer to a spatial receiving (RX) parameter.

In the context of the presented application, the term “beam identity/index (ID)” may refer to one or more of: a CSI-RS resource ID, a SSB resource ID, a CSI-RS resource indicator (CRI) or a SSB resource indicator (SSBRI). The term “bitwidth for information” or the term “uplink control information (UCI) payload size for information” may refer to payload size occupied by the information in UCI, or payload size or bitwidth of the information field.

Principles and implementations of the present disclosure will be described in detail below with reference to the figures.

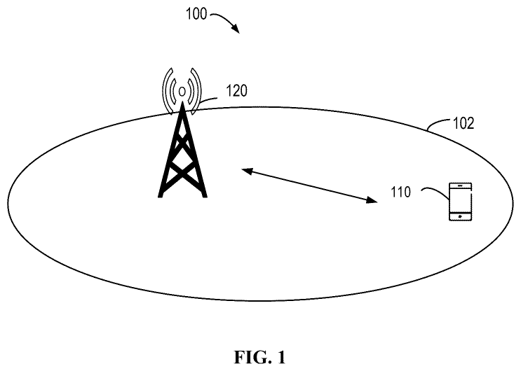

FIG. 1 illustrates a schematic diagram of an example communication environment 100 in which example embodiments of the present disclosure can be implemented. In the communication environment 100, a plurality of communication devices, including a terminal device 110 and a network device 120, can communicate with each other.

In the example of FIG. 1, the terminal device 110 may be a UE and the network device 120 may be a base station serving the UE. The serving area of the network device 120 may be called a cell 102.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100. It is noted that although illustrated as a network device, the network device 120 may be another device than a network device. Although illustrated as a terminal device, the terminal device 110 may be other device than a terminal device.

In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

In some example embodiments, if the terminal device 110 is a terminal device and the network device 120 is a network device, a link from the network device 120 to the terminal device 110 is referred to as a downlink (DL), while a link from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

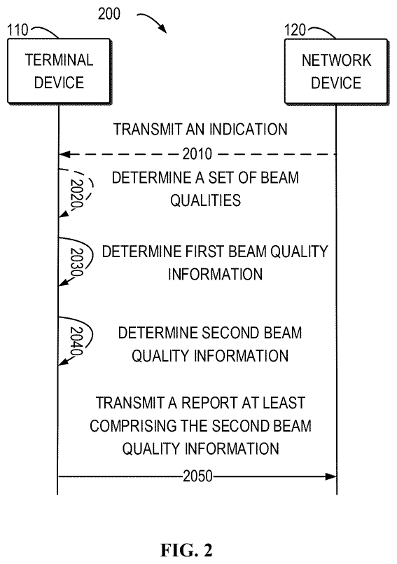

Reference is made to FIG. 2, which illustrates a signaling flow 200 of reporting angle information in accordance with some embodiments of the present disclosure. For the purposes of discussion, the signaling flow 200 will be discussed with reference to FIG. 1, for example, by using the terminal device 110 and the network device 120.

In some embodiments, the network device 120 may transmit 2010, to the terminal device 110, an indication for transmitting a report. For example, the network device 120 may trigger the terminal device 110 to transmit the port. In some embodiments, the report may refer to a beam report which is used to obtain beam qualities. For example, the report may be a CSI report. The indication may be transmitted via any proper signaling, for example, DCI or MAC signaling.

In some embodiments, the terminal device 110 may determine 2020 a set of beam qualities for a set of beams. For example, if the terminal device 110 is configured with a set of reference signal resources, the terminal device 110 may receive a set of reference signals on the set of reference signal resources and may measure the set of reference signals. In this case, the terminal device 110 may determine reference signal qualities of the set of reference signals based on the measurement. For example, the terminal device 110 may determine RSRP of the set of reference signals. Alternatively, or in addition, the terminal device 110 may determine SINR of the set of reference signals.

The terminal device 110 determines 2030 first beam quality information based on the set of beam qualities of the set of beams. In some embodiments, the terminal device 110 may determine the first beam quality information based on a predefined rule. For example, the predefined rule may be that one beam quality among the beam qualities to report can be the first beam quality. By way of example, the first beam quality can be the largest beam quality among the beam qualities to report. In this case, the first beam quality information may include the beset beam quality among the set of beam qualities.

In some embodiments, the predefined rule may be that more than one beam quality can be the first beam quality. For example, the first beam qualities can be top N (N>1) beam qualities among the beam qualities to report. In this case, the first beam quality information may include a subset of beam qualities from the set of beam qualities.

In some other embodiments, the predefined rule may be that each beam quality among the beam qualities to report is the first beam quality. In this case, the first beam quality information may include the set of beam qualities.

The terminal device 110 may determine the angle information based on the first beam quality information. In other words, there may be a correspondence between the first beam quality information and the angle information. For example, given a first beam quality, the angle information can be the circular function value of the angle of the Rx beam that is used to receive the Tx beam (i.e., RS) corresponding to the first beam quality.

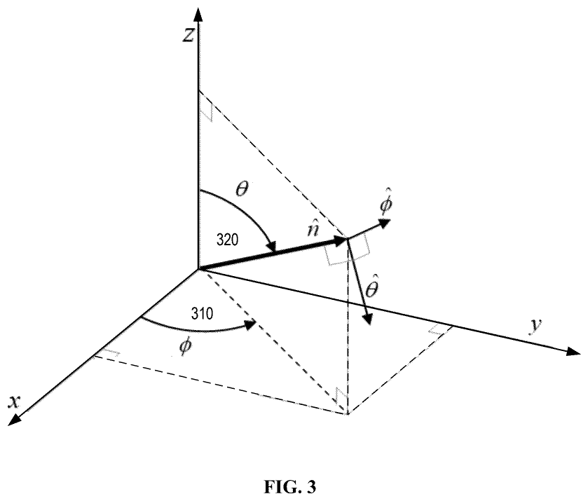

In some embodiments, the angle information may include a circular function value (referred to as “a first circular value” hereinafter) of a receiving beam angle of the terminal device 110. Alternatively, or in addition, the angle information may include a circular function (referred to as “a second circular value” hereinafter) of an angle of the terminal device 110. The circular function or circular value mentioned herein (for example, the first and second circular values) may include one or more of: a sine function, a cosine function, or a tangent function. It is noted that circular function may include any proper function. Referring to FIG. 3, the angle 310 may refer to an azimuth angle and the angle 320 may refer to a zenith angle.

Receiving beam angle information may refer to angle information (e.g., beam boresight direction, beam pointing angle) of DL received (or transmitted) beam at terminal device side. For example, the receiving beam angle may include a zenith angle (referred to as “a first zenith angle” hereinafter) of a beam (i.e., direction) that the terminal device 110 uses to receive signals from the network device 120 (for example, the set of reference signals). Alternatively, or in addition, the receiving beam angle may include an azimuth angle (referred to as “a first azimuth angle” hereinafter) of the beam that the terminal device 110 uses to receive signals from the network device 120. For example, assuming the zenith angle and azimuth angle of the Rx beam angle are π/2 and π/8. The angle information can include the sine value of the zenith angle, the cosine value of the zenith angle, the sine value of the azimuth angle and the cosine value of the azimuth angle, i.e., sin(π/2), cos(π/2), sin(π/8) and cos(π/8).

UE angle information may refer to the angle information of terminal device 110 (or panel/antenna array at terminal device side) relative to a reference position. In some embodiments, the reference position may be one or more of: a fixed position, a location or a point (e.g., gNB/TRP, panel/antenna array at gNB side). In some embodiments, the angle of the terminal device 110 may include a zenith angle (referred to as “a second zenith angle” hereinafter) of the terminal device 110 relative to a reference position. Alternatively, or in addition, the angle of the terminal device 110 may include an azimuth angle (referred to as “a second”) of the terminal device 110 relative to the reference position.

In some embodiments, the first beam quality information may include a measured value (referred to as “a first measured value” hereinafter) of a beam quality (referred to as “a first beam quality”). In this case, in some embodiments, the measured value may be in mW unit. Alternatively, the measured value may be in dBm unit. The dBm unit may be determined based on the formula: dBm=10 log₁₀ mW. For example, the measured value in mW may be 0.0000001 mW and the corresponding value in dBm may be −70 dBm.

Alternatively, the first beam quality information may include a quantized value of the beam quality. For example, the quantized value of the beam quality may refer to the bit value corresponding to the measured value of the beam quality.

By way of example, if the measured value in dBm of the L1-RSRP is −70 dBm, the corresponding quantized value of the L1-RSRP may be 87 based on the mapping table 1 (shown as below). It is noted that Table 1 is only an example not limitation.

TABLE 1

| | | Measured quantity | |
|---|---|---|---|
| Reported | Measured quantity | value(L1 SS-RSRP | |
| value | value(L3 SS-RSRP) | and CSI-RSRP) | Unit |
| RSRP_0 | SS-RSRP < −156 | Not valid | dBm |
| RSRP_1 | −156 ≤ SS-RSRP < −155 | Not valid | dBm |
| RSRP_2 | −155 ≤ SS-RSRP < −154 | Not valid | dBm |
| RSRP_3 | −154 ≤ SS-RSRP < −153 | Not valid | dBm |
| RSRP_4 | −153 ≤ SS-RSRP < −152 | Not valid | dBm |
| RSRP_5 | −152 ≤ SS-RSRP < −151 | Not valid | dBm |
| RSRP_6 | −151 ≤ SS-RSRP < −150 | Not valid | dBm |
| RSRP_7 | −150 ≤ SS-RSRP < −149 | Not valid | dBm |
| RSRP_8 | −149 ≤ SS-RSRP < −148 | Not valid | dBm |
| RSRP_9 | −148 ≤ SS-RSRP < −147 | Not valid | dBm |
| RSRP_10 | −147 ≤ SS-RSRP < −146 | Not valid | dBm |
| RSRP_11 | −146 ≤ SS-RSRP < −145 | Not valid | dBm |
| RSRP_12 | −145 ≤ SS-RSRP < −144 | Not valid | dBm |
| RSRP_13 | −144 ≤ SS-RSRP < −143 | Not valid | dBm |
| RSRP_14 | −143 ≤ SS-RSRP < −142 | Not valid | dBm |
| RSRP_15 | −142 ≤ SS-RSRP < −141 | Not valid | dBm |
| RSRP_16 | −141 ≤ SS-RSRP < −140 | Not valid | dBm |
| RSRP_17 | −140 ≤ SS-RSRP < −139 | RSRP < −139 | dBm |
| RSRP_18 | −139 ≤ SS-RSRP < −138 | −139 ≤ RSRP < −138 | dBm |
| . . . | . . . | | . . . |
| RSRP_111 | −46 ≤ SS-RSRP < −45 | −46 ≤ RSRP < −45 | dBm |
| RSRP_112 | −45 ≤ SS-RSRP < −44 | −45 ≤ RSRP | dBm |
| RSRP_113 | −44 ≤ SS-RSRP < −43 | Not valid | dBm |
| RSRP_114 | −43 ≤ SS-RSRP < −42 | Not valid | dBm |
| RSRP_115 | −42 ≤ SS-RSRP < −41 | Not valid | dBm |
| RSRP_116 | −41 ≤ SS-RSRP < −40 | Not valid | dBm |
| RSRP_117 | −40 ≤ SS-RSRP < −39 | Not valid | dBm |
| RSRP_118 | −39 ≤ SS-RSRP < −38 | Not valid | dBm |
| RSRP_119 | −38 ≤ SS-RSRP < −37 | Not valid | dBm |
| RSRP_120 | −37 ≤ SS-RSRP < −36 | Not valid | dBm |
| RSRP_121 | −36 ≤ SS-RSRP < −35 | Not valid | dBm |
| RSRP_122 | −35 ≤ SS-RSRP < −34 | Not valid | dBm |
| RSRP_123 | −34 ≤ SS-RSRP < −33 | Not valid | dBm |
| RSRP_124 | −33 ≤ SS-RSRP < −32 | Not valid | dBm |
| RSRP_125 | −32 ≤ SS-RSRP < −31 | Not valid | dBm |
| RSRP_126 | −31 ≤ SS-RSRP | Not valid | dBm |
| RSRP_127 | Infinity | Not valid | dBm |

In some embodiments, the type of value of the beam quality included in the first beam quality information may be configured by the network device 120. In other words, the network device 120 may configure the terminal device 110 whether the first beam quality information includes the measured value (in mW or in dBm) or the quantized value of the beam quality. For example, the terminal device 110 can be configured by the network device 120 with a RRC parameter that indicates the type of the beam quality.

Alternatively, the type of value of the beam quality included in the first beam quality information may be determined by an AI/ML model. For example, the terminal device 110 can determine the type of the beam quality based on the current applied AI/ML model (e.g., AI/ML model ID). Further, the AI/ML model may be indicated by the network device 120.

The terminal device 110 determines 2040 second beam quality information based on the first beam quality information and angle information associated with the terminal device 110. In some embodiments, the second beam quality information may comprise a product of a first value of the angle information and a second value of the first beam quality information. Alternatively, or in addition, the second beam quality information may be determined by other operation (e.g., addition, subtraction, division) of the first value of the angle information and the second value of the first beam quality information.

In some embodiments, the first value of the angle information may be an absolute value of the angle information. Alternatively, the first value of the angle information may be an original value (i.e., without any processing) of the angle information. In some embodiments, the second value of the first beam quality information may be the measured value of the beam quality (for example, as mentioned above). For example, the second value may be in mW unit or in dBm unit. Alternatively, the second value of the first beam quality information may be the quantized value of the beam quality (for example, as mentioned above).

For example, in some embodiments, if the beam quality included in the first beam quality information refers to the measured value in dBm and is 0.0000001 mW (i.e., 10⁻⁷), the second beam quality included in the second beam quality information can be 10⁻⁷*sin(π/2) mW, 10⁻⁷*cos(π/2) mW, 10⁻⁷*sin(π/8) mW or 10⁻⁷*cos(π/8) mW. In some embodiments, regardless of the type of the beam quality included in the first beam quality information, e.g., measured value in mW or dBm, or quantized value, the second beam quality included in the second beam quality information can be used as a feature, i.e., an input of the AI/ML model. It is noted that the first beam quality (e.g., L1-RSRP) may be referred to as “source RSRP” herein after, the second beam quality (i.e., the product of the first beam quality (e.g., L1-RSRP) and the circular function (e.g., sine, cosine) value of (the absolute value of) the Rx beam angle or UE angle) may be referred to as “sin RSRP” or “cos RSRP” hereinafter.

In some embodiments, the terminal device 110 may determine a second measured value of the second beam quality information based on the first measured value and the angle information. In this case, the terminal device 110 may determine a quantized value of the second measured value based on the second measured value. The report may include the quantized value of the second measured value.

For example, if the first beam quality is the measured value of the beam quality in mW, and based on some common angles (in degree) and the measured value in mW, the measured value in dBm and the quantized value of sin RSRP and cos RSRP may be shown in Table 2. It is noted that Table 2 is only an example not limitation. Only as an example, in Table 2, the mapping between the measured value in dBm and the quantized value is based on the mapping table 1.

TABLE 2

| | sin RSRP | | | cos RSRP | | |
|---|---|---|---|---|---|---|
| | Measured | Measured | | Measured | Measured | |
| Angle | value | value | Quantized | value | value | Quantized |
| (unit: °) | (mW) | (dBm) | value | (mW) | (dBm) | value |
| 0, (90) | 0 | / | / | 0.0000001 | −70 | RSRP_87 |
| 5, (85) | 0.0000000087 | −80.6 | RSRP_76 | 0.0000000996 | −70.02 | RSRP_86 |
| 10, (80) | 0.0000000174 | −77.6 | RSRP_79 | 0.0000000985 | −70.07 | RSRP_86 |
| 15, (75) | 0.0000000259 | −75.87 | RSRP_81 | 0.0000000966 | −70.15 | RSRP_86 |
| 22.5, (67.5) | 0.0000000383 | −74.17 | RSRP_82 | 0.0000000924 | −70.34 | RSRP_86 |
| 30, (60) | 0.00000005 | −73 | RSRP_84 | 0.0000000866 | −70.6 | RSRP_86 |
| 45 | 0.0000000707 | −71.5 | RSRP_85 | 0.0000000707 | −71.5 | RSRP_85 |

Notes:
when the angle is the value in ( ), the value of sin RSRP and cos RSRP are opposite.
RSRP_76, −81 ≤ RSRP < −80; RSRP_77, −80 ≤ RSRP < −79; RSRP_78, −79 ≤ RSRP < −78; RSRP_79, −78 ≤ RSRP < −77; RSRP_80, −77 ≤ RSRP < −76; RSRP_81, −76 ≤ RSRP < −75; RSRP_82, − 75 ≤ RSRP < −74; RSRP_83, −74 ≤ RSRP < −73; RSRP_84, −73 ≤ RSRP < −72; RSRP_85, −72 ≤ RSRP < −71; RSRP_86, −71 ≤ RSRP < −70; RSRP_87, −70 ≤ RSRP < −69; . . . RSRP_113, −44 ≤ RSRP

In some embodiments, the terminal device 110 may quantize the second measured to a first number of bits value in a predefined range with a first step size. For example, the measured value of sin RSRP or cos RSRP is quantized to a 7-bit value in the range [−140, −44] dBm with 1 dB step size. In other words, the terminal device 110 may report the quantized value corresponding to the sin RSRP or cos RSRP.

In some other embodiments, the terminal device 110 may quantize the second measured value a second number of bits value. The quantized value may be determined with a second step size with a reference to the first measured value. If the first measured value is in mW unit, the second number may be an integer number which is less than 7. For example, the measured value of sin RSRP or cos RSRP may be quantized to a N1-bit value (N1 is an positive integer, and N1<7). And the measured value of sin RSRP or cos RSRP may be determined with N2 dB step size with a reference to the measured value (in dBm) of the source RSRP which is part of the same L1-RSRP reporting instance (N2 is an positive integer). In this way, the overhead of the report can be reduced.

In some embodiments, if the angle information is associated with a predefined angle, the quantized value of the second measured value may be set to an invalid value. For example, if the angle is 0 or 180, the quantized (or reported) value of the sin RSRP can be one of the quantized values corresponding to “Not valid”, e.g., any one of RSRP_0˜15 and RSRP 114˜127. If the angle is 90, the quantized (or reported) value of the cos RSRP can be one of the quantized values corresponding to “Not valid”. Additionally, RSRP_16 and RSRP_113 also can be adopted.

In some embodiments, if the first beam quality is the measured value of the beam quality in dBm, and based on some common angles (in degree), the measured value in dBm and the quantized value of sin RSRP and cos RSRP can be shown in Table 3 below. It is noted that in Table 3, the mapping between the measured value in dBm and the quantized value is based on the mapping table 1. Table 3 is only an example not limitation.

TABLE 3

| | sin RSRP | | cos RSRP | |
|---|---|---|---|---|
| | Measured | | Measured | |
| Angle | value | Quantized | value | Quantized |
| (unit: °) | (dBm) | value | (dBm) | value |
| 0, (90) | 0 | RSRP_113 | −70 | RSRP_87 |
| 5, (85) | −6.1 | RSRP_113 | −69.73 | RSRP_87 |
| 10, (80) | −12.16 | RSRP_113 | −68.94 | RSRP_88 |
| 15, (75) | −18.12 | RSRP_113 | −67.61 | RSRP_89 |
| 22.5, (67.5) | −26.79 | RSRP_113 | −64.67 | RSRP_92 |
| 30, (60) | −35 | RSRP_113 | −60.62 | RSRP_96 |
| 45 | −49.5 | RSRP_107 | −49.5 | RSRP_107 |

Notes:
when the angle is the value in ( ), the value of sin RSRP and cos RSRP are opposite.
RSRP_87, −70 ≤ RSRP < −69; RSRP_88, −69 ≤ RSRP < −68; RSRP_89, −68 ≤ RSRP < −67; RSRP_90, −67 ≤ RSRP < −66; RSRP_91, −66 ≤ RSRP < −65; RSRP_92, −65 ≤ RSRP < −64; RSRP_93, −64 ≤ RSRP < −63; RSRP_94, −63 ≤ RSRP < −62; RSRP_95, −62 ≤ RSRP < −61; RSRP_96, −61 ≤ RSRP < −60; RSRP_97, −60 ≤ RSRP < −59; RSRP_98, −59 ≤ RSRP < −58; . . . RSRP_107, −50 ≤ RSRP < −49; RSRP_111, −46 ≤ RSRP < −45; RSRP_112, −45 ≤ RSRP <− 44; RSRP_110, −47 ≤ RSRP < −46; RSRP_111, −46 ≤ RSRP < −45; RSRP_112, −45 ≤ RSRP < −44; RSRP_113, −44 ≤ RSRP

In some embodiments, considering that the measured value of the sin RSRP or cos RSRP may be larger than −44 dBm commonly and the corresponding quantized value is always RSRP_113 based on the mapping table 1, the difference between different angles may not be significant. Thus, in some embodiments, the mapping table 1 may be extended or modified, for example, adding valid bits, i.e., for the reported values mapping/associated with “Not valid”, assigning a valid measured quantity value. E.g., −44≤RSRP<43 for RSRP_113, −43≤RSRP<42 for RSRP_114.

Alternatively, if the first measured value is in dBm unit, the quantized value of the second measured value may be determined based on a first mapping table. If the first measured value is in mW unit, the quantized value of the second measured value may be determined based on a second mapping table. In this case, the first mapping table may be different from the second mapping table (for example, mapping table 1 shown as above) that is used if the first measured value is in mW unit. Specifically, the reported value and the measured quantity value may have a new mapping relationship different from that of the mapping table 1.

In some embodiments, the measured value of sin RSRP or cos RSRP may be quantized to a P1-bit value in the range [P2, P3] dBm with P4 dB step size. In this case, P1 or P4 may be a positive integer. P2 or P3 may be an integer and P2 is smaller than P3.

In some other embodiments, the measured value of sin RSRP or cos RSRP may be quantized to a M1-bit value. And the measured value of sin RSRP or cos RSRP may be determined with M2 dB step size with a reference to the measured value (in dBm) of the source RSRP which is part of the same L1-RSRP reporting instance. In this case, in some embodiments, M1 or M2 may be an positive integer, and N≤7.

In some embodiments, if the first beam quality is the quantized (or reported) value of the beam quality, and based on some common angles (in degree), the quantized (or reported) value of sin RSRP and cos RSRP can be shown in Table 4 below. Quantized value with non-processing may refer to the value of sin RSRP or cos RSRP that is not rounded, e.g., the product of 87 and sin (5). Quantized value with processing may refer to the value of sin RSRP or cos RSRP after rounding. In other words, the quantized value with processing refers to the quantized or reported value of sin RSRP or cos RSRP. It is noted that Table 4 is only an example not limitation.

TABLE 4

| | sin RSRP | | cos RSRP | |
|---|---|---|---|---|
| | Quantized | | Quantized | |
| | value with | Quantized | value with | Quantized |
| Angle | non- | value with | non- | value with |
| (unit: °) | processing | processing | processing | processing |
| 0, (90) | 0 | RSRP_0 | 87 | RSRP_87 |
| 5, (85) | 7.58 | RSRP_8 | 86.67 | RSRP_87 |
| 10, (80) | 15.11 | RSRP_15 | 85.68 | RSRP_86 |
| 15, (75) | 22.52 | RSRP_23 | 84.04 | RSRP_84 |
| 22.5, (67.5) | 33.29 | RSRP_33 | 80.38 | RSRP_80 |
| 30, (60) | 43.5 | RSRP_44 | 75.34 | RSRP_75 |
| 45 | 61.52 | RSRP_62 | 61.52 | RSRP_62 |

Notes:
when the angle is the value in ( ), the value of sin RSRP and cos RSRP are opposite.

In some embodiments, the terminal device 110 may determine a real value of the second beam quality information based on the first quantized value and the angle information. In this case, the terminal device 110 may determine a second quantized value of the real value based on a predefined round rule. The report may include the second quantized value. For example, the predefined round rule may comprise one of: round, round up or round down.

The terminal device 110 transmits 2050 a report to the network device 120. The report at least includes the second beam quality information. In some embodiments, the report may include the first beam quality information. Alternatively, or in addition, the report may include the angle information associated with the terminal device 110.

In some embodiments, the report may include first information that indicates whether the angle information is positive or negative. For example, a new CSI field (e.g., first indicator) can be introduced in the beam report, and the first indicator is used to indicate whether the angle information is positive or negative. The first indicator may be associated with (or corresponds) a specific sin RSRP or cos RSRP. It means that, if the first indicator indicates “negative”, after gNB receives the corresponding sin RSRP or cos RSRP, the received corresponding sin RSRP or RSRP needs to be multiplied by “−1”. The first indicator can occur 1 bit. The bit values of “0” or “1” can indicate positive or negative of the angle information.

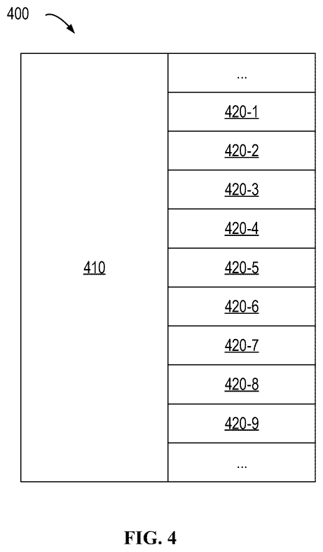

In some embodiments, the sin RSRP, the cos RSRP, the source RSRP and the first indicator need to report in the beam report. The angle information corresponding to the zenith angle and the azimuth angle need to report in the beam report. The mapping order of these necessary information in the beam report can be as follows. The omitted part may be beam ID (i.e., CRI or SSBRI) corresponding to the source RSRP/sin RSRP/cos RSRP, or sin RSRP, cos RSRP, source RSRP, first indicator or beam ID corresponding to other beams to report in the beam report. Furthermore, the mapping order between different information (e.g., zenith angle and azimuth angle, sin RSRP and cos RSRP) can be reversed. FIG. 4 shows an example of CSI report 400. As shown in FIG. 4, the CSI report 400 may include the field 410 indicating CSR report number, a field 420-1 indicating the source RSRP, a field 420-2 including the first indictor, a field 420-3 indicating sin RSRP, a field 420-4 including the first indicator, a field 420-5 indicating cos RSRP, a field 420-6 including the first indictor, a field 420-7 indicating sin RSRP, a field 420-8 including the first indicator, a field 420-9 indicating cos RSRP. The fields 420-2, 420-3, 420-4, 420-5 may include information associated with the zenith angle and the fields 420-6, 420-7, 420-8, 420-9 may include information associated with the azimuth angle.

In some embodiments, the terminal device 110 may determine a circular value type associated with the second beam quality information based on a predefined condition. In some embodiments, a given angle in degree, the predefined rules may be based on value of the angle. For example, when 0<|angle|≤45, or 135≤|angle|<180, the sin RSRP can be selected. When 45<|angle|≤135, the cos RSRP can be selected. When |angle|=0 or 180, the cos RSRP can be selected (or the sin RSRP can be selected). When |angle|=90, the sin RSRP can be selected (or the cos RSRP can be selected). In some embodiments, a given angle in degree, the predefined rules may be based on values of the sine or cosine value of the angle. For example, when the absolute value of the sine value of the angle (i.e., measured value of the sin RSRP) is less than or equal to the absolute value of the cosine value of the angle (i.e., measured value of the cos RSRP), the sin RSRP can be selected. Otherwise, the cos RSRP can be selected. When the absolute value of the sine value of the angle is equal to 1 (or the cosine value of the angle is equal to 1), the sin RSRP (or cos RSRP) can be selected.

In some embodiments, when 0<|angle|≤45, or 135≤|angle|<180, the cos RSRP can be selected. When 45<|angle|≤135, the sin RSRP can be selected. When |angle|=0 or 180, the sin RSRP can be selected (or the cos RSRP can be selected). When |angle|=90, the cos RSRP can be selected (or the sin RSRP can be selected). In some embodiments, when the absolute value of the cosine value of the angle (i.e., measured value of the cos RSRP) is larger than or equal to the absolute value of the sine value of the angle (i.e., measured value of the sin RSRP), the cos RSRP can be selected. Otherwise, the sin RSRP can be selected. In some embodiments, when the absolute value of the cosine value of the angle is equal to 1 (or the sine value of the angle is equal to 1), the cos RSRP (or sin RSRP) can be selected.

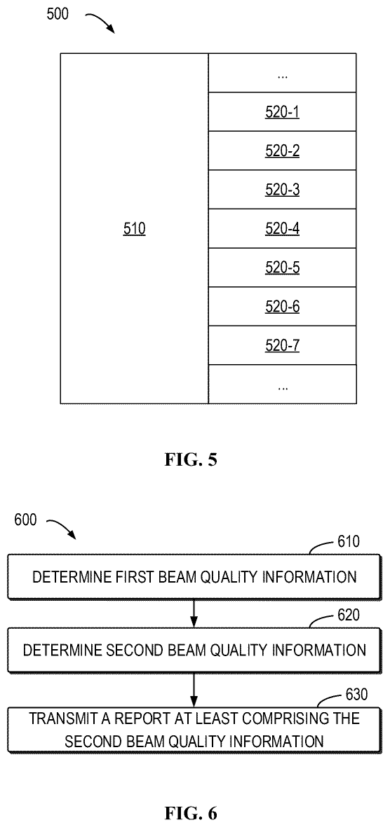

In some embodiments, the report may include second information that indicates a circular value type associated with the second beam quality information. For example, a new indicator or CSI field (e.g., second indicator) can be introduced in the beam report. In some embodiments, the second indicator may be associated with (or correspond) a specific source RSRP, sin RSRP or cos RSRP. The second indicator may be used to indicate whether the corresponding second beam quality is sin RSRP or cos RSRP. In some embodiments, the second indicator can occur 1 bit. The bit values of “0” or “1” can indicate whether the corresponding second beam quality is sin RSRP or cos RSRP. Assuming that the beam report includes at least sin RSRP or cos RSRP, source RSRP, first indicator and second indicator, and the angle information corresponding to the zenith angle and the azimuth angle need to report in the beam report. The mapping order of these information in the beam report can be shown in FIG. 5. Furthermore, the mapping order between different information can be reversed. As shown in FIG. 5, the CSI report 500 may include the field 510 indicating CSR report number, a field 520-1 indicating the source RSRP, a field 520-2 including the first indictor, a field 520-3 including the second indicator, a field 520-4 indicating a sin RSRP or cos RSRP, a field 520-5 including the first indicator, a field 520-6 including a second indicator, a field 520-7 indicating sin RSRP or cos RSRP. The fields 520-2, 520-3, 520-4 may include information associated with the zenith angle and the fields 520-5, 520-6, 520-7 may include information associated with the azimuth angle.

FIG. 6 illustrates a flowchart of a communication method 600 implemented at a terminal device in accordance with some embodiments of the present disclosure. For the purpose of discussion, the method 600 will be described from the perspective of the terminal device 110 in FIG. 1.

At block 610, the terminal device determines first beam quality information based on a set of beam qualities of a set of beams. In some example embodiments, a beam in the set of beams comprises at least one of: a channel state information reference signal (CSI-RS) resource, or a synchronization signal/physical broadcast channel (SSB) resource. In some embodiments, a beam quality of the beam comprises a RSRP. Alternatively, or in addition, the beam quality may comprise a SINR.

At block 620, the terminal device determines second beam quality information based on the first beam quality information and angle information associated with the terminal device. In some example embodiments, the angle information comprises at least one of: a first circular value of a receiving beam angle of the terminal device, or a second circular value of an angle of the terminal device. In some example embodiments, the angle information is determined based on the first beam quality information.

At block 630, the terminal device transmits, to a network device, a report that at least comprises the second beam quality information.

In some example embodiments, the receiving beam angle comprises at least one of: a first zenith angle of the receiving beam that the terminal device uses to receive a signal from the network device, or a first azimuth angle of the receiving beam that the terminal device uses to receive the signal from the network device.

In some example embodiments, the angle associated with the terminal device comprises: a second zenith angle of the terminal device relative to a reference position, or a second azimuth angle of the terminal device relative to the reference position.

In some example embodiments, the first beam quality information comprises a best beam quality among the set of beam qualities, or wherein the first beam quality information comprises a subset of beam qualities from the set of beam qualities, or wherein the first beam quality information comprises the set of beam qualities.

In some example embodiments, the first beam quality information comprises a first measured value of a beam quality. In some example embodiments, the first measured value is in mW unit. Alternatively, the first measured value may be in dBm unit. In some example embodiments, the first beam quality information comprises a quantized value of a beam quality.

In some example embodiments, the second beam quality information comprises a product of a first value of the angle information and a second value of the first beam quality information.

In some example embodiments, the terminal device may determine a second measured value of the second beam quality information based on the first measured value and the angle information. The terminal device may also determine a quantized value of the second measured value based on the second measured value. The report may include the quantized value of the second measured value.

In some example embodiments, the terminal device may determine the quantized value by quantizing the second measured value to a first number of bits value in a predefined range with a first step size. In some example embodiments, the terminal device may determine the quantized value by quantizing the second measured value to a second number of bits value, and the quantized value is determined with a second step size with a reference to the first measured value.

In some example embodiments, if the first measured value is in mW unit, the second number is an integer number which is less than 7. In some example embodiments, if the angle information is associated with a predefined angle, the quantized value of the second measured value is set to an invalid value.

In some example embodiments, if the first measured value is in dBm unit, the quantized value of the second measured value is determined based on a first mapping table, and wherein if the first measured value is in mW unit, the quantized value of the second measured value is determined based on a second mapping table.

In some example embodiments, the terminal device may determine a real value of the second beam quality information based on the first quantized value and the angle information. In this case, the terminal device may also determine a second quantized value of the real value based on a predefined round rule. The report may include the second quantized value.

In some example embodiments, the terminal device may determine a circular value type associated with the second beam quality information based on a predefined condition. In some embodiments, the predefined condition may be based on at least one of: an angle value associated with the angle information, or a circular value associated with the angle information.

In some example embodiments, the predefined condition may comprise at least one of: if an absolute value of an angle associated with the angle information is between 0 and 45 degree or between 135 and 180 degree, the circular value type associated with the second beam quality information is sine value, if the absolute value is between 45 and 135 degree, the circular value type associated with the second beam quality information is cosine value, if the angle is 0 or 180 degree, the circular value type associated with the second beam quality information is cosine value, if the angle is 90 degree, the circular value type associated with the second beam quality information is sine value, if a first absolute value of a sine value of the angle is not larger than a second absolute value of a cosine value of the angle, the circular value type associated with the second beam quality information is sine value, or if the first absolute value of the sine value of the angle is larger than the second absolute value of the cosine value of the angle, the circular value type associated with the second beam quality information is cosine value.

In some example embodiments, the predefined condition may comprise at least one of: if an absolute value of an angle associated with the angle information is between 0 and 45 degree or between 135 and 180 degree, the circular value type associated with the second beam quality information is cosine value, if the absolute value is between 45 and 135 degree, the circular value type associated with the second beam quality information is sine value, if the angle is 0 or 180 degree, the circular value type associated with the second beam quality information is sine value, if the angle is 90 degree, the circular value type associated with the second beam quality information is cosine value, if a first absolute value of a cosine value of the angle is not smaller than a second absolute value of a sine value of the angle, the circular value type associated with the second beam quality information is cosine value, or if the first absolute value of the cosine value of the angle is smaller than the second absolute value of the sine value of the angle, the circular value type associated with the second beam quality information is since value.

In some example embodiments, the report also comprises at least one of: the first beam quality information, the angle information, first information that indicates whether the angle information is positive or negative, or second information that indicates a circular value type associated with the second beam quality information.

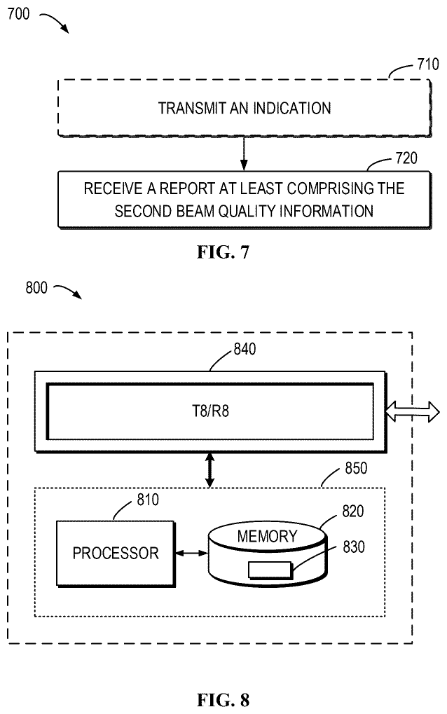

FIG. 7 illustrates a flowchart of a communication method 700 implemented at a network device in accordance with some embodiments of the present disclosure. For the purpose of discussion, the method 700 will be described from the perspective of the network device 120 in FIG. 1.

In some embodiments, at block 710, the network device may transmit, to the terminal device, an indication for transmitting a report. For example, the network device may trigger the terminal device to transmit the port. In some embodiments, the report may refer to a beam report which is used to obtain beam qualities. For example, the report may be a CSI report. The indication may be transmitted via any proper signaling, for example, DCI or MAC signaling.

At block 720, the network device receives a report that at least comprises second beam quality information from the terminal device. The second beam quality information is determined based on first beam quality information and angle information associated with the terminal device. The first beam quality information is determined based on a set of beam qualities of a set of beams.

In some example embodiments, a beam in the set of beams comprises at least one of: a channel state information reference signal (CSI-RS) resource, or a synchronization signal/physical broadcast channel (SSB) resource. In some embodiments, a beam quality of the beam comprises a RSRP or SINR.

In some example embodiments, the angle information comprises at least one of: a first circular value of a receiving beam angle of the terminal device, or a second circular value of an angle of the terminal device. In some example embodiments, the angle information is determined based on the first beam quality information.

In some example embodiments, the receiving beam angle comprises at least one of: a first zenith angle of the receiving beam that the terminal device uses to receive a signal from the network device, or a first azimuth angle of the receiving beam that the terminal device uses to receive the signal from the network device.

In some example embodiments, the angle associated with the terminal device comprises: a second zenith angle of the terminal device relative to a reference position, or a second azimuth angle of the terminal device relative to the reference position.

In some example embodiments, the first beam quality information comprises a best beam quality among the set of beam qualities, or wherein the first beam quality information comprises a subset of beam qualities from the set of beam qualities, or wherein the first beam quality information comprises the set of beam qualities.

In some example embodiments, the first beam quality information comprises a first measured value of a beam quality. In some example embodiments, the first measured value is in mW unit. Alternatively, the first measured value may be in dBm unit. In some example embodiments, the first beam quality information comprises a quantized value of a beam quality.

In some example embodiments, the second beam quality information comprises a product of a first value of the angle information and a second value of the first beam quality information.

In some example embodiments, a second measured value of the second beam quality information may be determined based on the first measured value and the angle information. A quantized value of the second measured value may be determined based on the second measured value. The report may include the quantized value of the second measured value.

In some example embodiments, the quantized value may be determined by quantizing the second measured value to a first number of bits value in a predefined range with a first step size. In some example embodiments, the quantized value may be determined by quantizing the second measured value to a second number of bits value, and the quantized value is determined with a second step size with a reference to the first measured value.

In some example embodiments, if the first measured value is in mW unit, the second number is an integer number which is less than 7. In some example embodiments, if the angle information is associated with a predefined angle, the quantized value of the second measured value is set to an invalid value.

In some example embodiments, if the first measured value is in dBm unit, the quantized value of the second measured value is determined based on a first mapping table, and wherein if the first measured value is in mW unit, the quantized value of the second measured value is determined based on a second mapping table. In some example embodiments, the quantized value of the second measured value is rounded based on a rule.

In some example embodiments, a circular value type associated with the second beam quality information may be determined based on a predefined condition. In some embodiments, the predefined condition may be based on at least one of: an angle value associated with the angle information, or a circular value associated with the angle information.

In some example embodiments, the predefined condition may comprise at least one of: if an absolute value of an angle associated with the angle information is between 0 and 45 degree or between 135 and 180 degree, the circular value type associated with the second beam quality information is sine value, if the absolute value is between 45 and 135 degree, the circular value type associated with the second beam quality information is cosine value, if the angle is 0 or 180 degree, the circular value type associated with the second beam quality information is cosine value, if the angle is 90 degree, the circular value type associated with the second beam quality information is sine value, if a first absolute value of a sine value of the angle is not larger than a second absolute value of a cosine value of the angle, the circular value type associated with the second beam quality information is sine value, or if the first absolute value of the sine value of the angle is larger than the second absolute value of the cosine value of the angle, the circular value type associated with the second beam quality information is cosine value.

In some example embodiments, the predefined condition may comprise at least one of: if an absolute value of an angle associated with the angle information is between 0 and 45 degree or between 135 and 180 degree, the circular value type associated with the second beam quality information is cosine value, if the absolute value is between 45 and 135 degree, the circular value type associated with the second beam quality information is sine value, if the angle is 0 or 180 degree, the circular value type associated with the second beam quality information is sine value, if the angle is 90 degree, the circular value type associated with the second beam quality information is cosine value, if a first absolute value of a cosine value of the angle is not smaller than a second absolute value of a sine value of the angle, the circular value type associated with the second beam quality information is cosine value, or if the first absolute value of the cosine value of the angle is smaller than the second absolute value of the sine value of the angle, the circular value type associated with the second beam quality information is since value.

In some example embodiments, the report also comprises at least one of: the first beam quality information, the angle information, first information that indicates whether the angle information is positive or negative, or second information that indicates a circular value type associated with the second beam quality information.

FIG. 8 is a simplified block diagram of a device 800 that is suitable for implementing embodiments of the present disclosure. The device 800 can be considered as a further example implementation of any of the devices as shown in FIG. 1. Accordingly, the device 800 can be implemented at or as at least a part of the terminal device 110 or the network device 120.

As shown, the device 800 includes a processor 810, a memory 820 coupled to the processor 810, a suitable transmitter (TX)/receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 1 to 8. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises a circuitry configured to: determine, first beam quality information based on a set of beam qualities of a set of beams; determine second beam quality information based on the first beam quality information and angle information associated with the terminal device; and transmit, to a network device, a report that at least comprises the second beam quality information.

According to embodiments of the present disclosure, the circuitry may be configured to perform any of the method implemented by the terminal device as discussed above.

In some embodiments, a network device comprises a circuitry configured to: receive, from a terminal device, a report that at least comprises second beam quality information, wherein the second beam quality information is determined based on first beam quality information and angle information associated with the terminal device, and wherein the first beam quality information is determined based on a set of beam qualities of a set of beams.

According to embodiments of the present disclosure, the circuitry may be configured to perform any of the method implemented by the network device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, a communication method, comprising: determining, at a terminal device, first beam quality information based on a set of beam qualities of a set of beams; determining second beam quality information based on the first beam quality information and angle information associated with the terminal device; and transmitting, to a network device, a report that at least comprises the second beam quality information.

In some embodiments, a beam in the set of beams comprises at least one of: a channel state information reference signal (CSI-RS) resource, or a synchronization signal/physical broadcast channel (SSB) resource, and wherein a beam quality of the beam comprises a RSRP or SINR.

In some embodiments, the angle information comprises at least one of: a first circular value of a receiving beam angle of the terminal device, or a second circular value of an angle of the terminal device.

In some embodiments, the receiving beam angle comprises at least one of: a first zenith angle of the receiving beam that the terminal device uses to receive a signal from the network device, or a first azimuth angle of the receiving beam that the terminal device uses to receive the signal from the network device.

In some embodiments, the angle of the terminal device comprises: a second zenith angle of the terminal device relative to a reference position, or a second azimuth angle of the terminal device relative to the reference position.

In some embodiments, the first beam quality information comprises a best beam quality among the set of beam qualities, or wherein the first beam quality information comprises a subset of beam qualities from the set of beam qualities, or wherein the first beam quality information comprises the set of beam qualities.

In some embodiments, the angle information is determined based on the first beam quality information.

In some embodiments, the first beam quality information comprises a first measured value of a beam quality, and wherein the first measured value is in mW unit, or wherein the first measured value is in dBm unit.

In some embodiments, the first beam quality information comprises a first quantized value of a beam quality.

In some embodiments, the second beam quality information comprises a product of a first value of the angle information and a second value of the first beam quality information.

In some embodiments, the method further comprises: determining a second measured value of the second beam quality information based on the first measured value and the angle information; and determining a quantized value of the second measured value based on the second measured value, and wherein the report comprises the quantized value of the second measured value.

In some embodiments, determining the quantized value of the second measured value comprises: determining the quantized value by quantizing the second measured value to a first number of bits value in a predefined range with a first step size.

In some embodiments, determining the quantized value of the second measured value comprises: determining the quantized value by quantizing the second measured value to a second number of bits value, and the quantized value is determined with a second step size with a reference to the first measured value.

In some embodiments, if the first measured value is in mW unit, the second number is an integer number which is less than 7.

In some embodiments, if the angle information is associated with a predefined angle, the quantized value of the second measured value is set to an invalid value.

In some embodiments, if the first measured value is in dBm unit, the quantized value of the second measured value is determined based on a first mapping table, and wherein if the first measured value is in mW unit, the quantized value of the second measured value is determined based on a second mapping table.

In some embodiments, the method comprises determining a real value of the second beam quality information based on the first quantized value and the angle information; and determining a second quantized value of the real value based on a predefined round rule, wherein the report comprises the second quantized value.

In some embodiments, the method further comprises: determining a circular value type associated with the second beam quality information based on a predefined condition, and wherein the predefined condition is based on at least one of: an angle value associated with the angle information, or a circular value associated with the angle information.

In some example embodiments, the predefined condition may comprise at least one of: if an absolute value of an angle associated with the angle information is between 0 and 45 degree or between 135 and 180 degree, the circular value type associated with the second beam quality information is sine value, if the absolute value is between 45 and 135 degree, the circular value type associated with the second beam quality information is cosine value, if the angle is 0 or 180 degree, the circular value type associated with the second beam quality information is cosine value, if the angle is 90 degree, the circular value type associated with the second beam quality information is sine value, if a first absolute value of a sine value of the angle is not larger than a second absolute value of a cosine value of the angle, the circular value type associated with the second beam quality information is sine value, or if the first absolute value of the sine value of the angle is larger than the second absolute value of the cosine value of the angle, the circular value type associated with the second beam quality information is cosine value.

In some example embodiments, the predefined condition may comprise at least one of: if an absolute value of an angle associated with the angle information is between 0 and 45 degree or between 135 and 180 degree, the circular value type associated with the second beam quality information is cosine value, if the absolute value is between 45 and 135 degree, the circular value type associated with the second beam quality information is sine value, if the angle is 0 or 180 degree, the circular value type associated with the second beam quality information is sine value, if the angle is 90 degree, the circular value type associated with the second beam quality information is cosine value, if a first absolute value of a cosine value of the angle is not smaller than a second absolute value of a sine value of the angle, the circular value type associated with the second beam quality information is cosine value, or if the first absolute value of the cosine value of the angle is smaller than the second absolute value of the sine value of the angle, the circular value type associated with the second beam quality information is since value.

In some example embodiments, the report also comprises at least one of: the first beam quality information, the angle information, first information that indicates whether the angle information is positive or negative, or second information that indicates a circular value type associated with the second beam quality information.

In some embodiments, the report also comprises at least one of: the first beam quality information, the angle information, first information that indicates whether the angle information is positive or negative, or second information that indicates a circular value type associated with the second beam quality information.

In an aspect, a terminal device comprises: at least one processor; and at least one memory coupled to the at least one processor and storing instructions thereon, the instructions, when executed by the at least one processor, causing the device to perform the method implemented by the terminal device discussed above.

In an aspect, a communication method, comprising: receiving, at a network device and from a terminal device, a report that at least comprises second beam quality information, wherein the second beam quality information is determined based on first beam quality information and angle information associated with the terminal device, and wherein the first beam quality information is determined based on a set of beam qualities of a set of beams.

In some example embodiments, a beam in the set of beams comprises at least one of: a channel state information reference signal (CSI-RS) resource, or a synchronization signal/physical broadcast channel (SSB) resource. In some embodiments, a beam quality of the beam comprises a RSRP or SINR.

In some example embodiments, the angle information comprises at least one of: a first circular value of a receiving beam angle of the terminal device, or a second circular value of an angle of the terminal device. In some example embodiments, the angle information is determined based on the first beam quality information.

In some example embodiments, the receiving beam angle comprises at least one of: a first zenith angle of the receiving beam that the terminal device uses to receive a signal from the network device, or a first azimuth angle of the receiving beam that the terminal device uses to receive the signal from the network device.

In some example embodiments, the angle of the terminal device comprises: a second zenith angle of the terminal device relative to a reference position, or a second azimuth angle of the terminal device relative to the reference position.

In some example embodiments, the first beam quality information comprises a best beam quality among the set of beam qualities, or wherein the first beam quality information comprises a subset of beam qualities from the set of beam qualities, or wherein the first beam quality information comprises the set of beam qualities.

In some example embodiments, the first beam quality information comprises a first measured value of a beam quality. In some example embodiments, the first measured value is in mW unit. Alternatively, the first measured value may be in dBm unit. In some example embodiments, the first beam quality information comprises a quantized value of a beam quality.

In some example embodiments, the second beam quality information comprises a product of a first value of the angle information and a second value of the first beam quality information.

In some example embodiments, a second measured value of the second beam quality information may be determined based on the first measured value and the angle information. A quantized value of the second measured value may be determined based on the second measured value. The report may include the quantized value of the second measured value.

In some example embodiments, the quantized value is determined by quantizing the second measured value to a first number of bits value in a predefined range with a first step size. In some example embodiments, the quantized value is determined by quantizing the second measured value to a second number of bits value, and the quantized value is determined with a second step size with a reference to the first measured value.

In some example embodiments, if the first measured value is in mW unit, the second number is an integer number which is less than 7. In some example embodiments, if the angle information is associated with a predefined angle, the quantized value of the second measured value is set to an invalid value.

In some example embodiments, if the first measured value is in dBm unit, the quantized value of the second measured value is determined based on a first mapping table, and wherein if the first measured value is in mW unit, the quantized value of the second measured value is determined based on a second mapping table. In some example embodiments, the quantized value of the second measured value is rounded based on a rule.

In some example embodiments, a circular value type associated with the second beam quality information may be determined based on a predefined condition. In some embodiments, the predefined condition may be based on at least one of: an angle value associated with the angle information, or a circular value associated with the angle information.

In some example embodiments, the predefined condition may comprise at least one of: if an absolute value of an angle associated with the angle information is between 0 and 45 degree or between 135 and 180 degree, the circular value type associated with the second beam quality information is sine value, if the absolute value is between 45 and 135 degree, the circular value type associated with the second beam quality information is cosine value, if the angle is 0 or 180 degree, the circular value type associated with the second beam quality information is cosine value, if the angle is 90 degree, the circular value type associated with the second beam quality information is sine value, if a first absolute value of a sine value of the angle is not larger than a second absolute value of a cosine value of the angle, the circular value type associated with the second beam quality information is sine value, or if the first absolute value of the sine value of the angle is larger than the second absolute value of the cosine value of the angle, the circular value type associated with the second beam quality information is cosine value.

In some example embodiments, the predefined condition may comprise at least one of: if an absolute value of an angle associated with the angle information is between 0 and 45 degree or between 135 and 180 degree, the circular value type associated with the second beam quality information is cosine value, if the absolute value is between 45 and 135 degree, the circular value type associated with the second beam quality information is sine value, if the angle is 0 or 180 degree, the circular value type associated with the second beam quality information is sine value, if the angle is 90 degree, the circular value type associated with the second beam quality information is cosine value, if a first absolute value of a cosine value of the angle is not smaller than a second absolute value of a sine value of the angle, the circular value type associated with the second beam quality information is cosine value, or if the first absolute value of the cosine value of the angle is smaller than the second absolute value of the sine value of the angle, the circular value type associated with the second beam quality information is since value.

In some example embodiments, the report also comprises at least one of: the first beam quality information, the angle information, first information that indicates whether the angle information is positive or negative, or second information that indicates a circular value type associated with the second beam quality information.

In an aspect, a network device comprises: at least one processor; and at least one memory coupled to the at least one processor and storing instructions thereon, the instructions, when executed by the at least one processor, causing the device to perform the method implemented by the network device discussed above.

In an aspect, a computer readable medium having instructions stored thereon, the instructions, when executed on at least one processor, causing the at least one processor to perform the method implemented by the terminal device discussed above.

In an aspect, a computer readable medium having instructions stored thereon, the instructions, when executed on at least one processor, causing the at least one processor to perform the method implemented by the network device discussed above.

In an aspect, a computer program comprising instructions, the instructions, when executed on at least one processor, causing the at least one processor to perform the method implemented by the terminal device discussed above.

In an aspect, a computer program comprising instructions, the instructions, when executed on at least one processor, causing the at least one processor to perform the method implemented by the network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A communication method, comprising:
determining, at a terminal device, first beam quality information based on a set of beam qualities of a set of beams;
determining second beam quality information based on the first beam quality information and angle information associated with the terminal device; and
transmitting, to a network device, a report that at least comprises the second beam quality information.

2. The method of claim 1, wherein a beam in the set of beams comprises at least one of:
a channel state information reference signal (CSI-RS) resource, or
a synchronization signal/physical broadcast channel (SSB) resource, and
wherein a beam quality of the beam comprises at least one of:
a reference signal receiving power (RSRP), or
a signal to interference plus noise ratio (SINR).

3. The method of claim 1, wherein the angle information comprises at least one of:
a first circular value of a receiving beam angle of the terminal device, or
a second circular value of an angle of the terminal device.

4. The method of claim 3, wherein the receiving beam angle comprises at least one of:
a first zenith angle of the receiving beam that the terminal device uses to receive a signal from the network device, or
a first azimuth angle of the receiving beam that the terminal device uses to receive the signal from the network device.

5. The method of claim 3, wherein the angle of the terminal device comprises:
a second zenith angle of the terminal device relative to a reference position, or
a second azimuth angle of the terminal device relative to the reference position.

6. The method of claim 1, wherein the first beam quality information comprises a best beam quality among the set of beam qualities, or
wherein the first beam quality information comprises a subset of beam qualities from the set of beam qualities, or
wherein the first beam quality information comprises the set of beam qualities.

7. The method of claim 1, wherein the angle information is determined based on the first beam quality information.

8. The method of claim 1, wherein the second beam quality information comprises a product of a first value of the angle information and a second value of the first beam quality information, and
wherein the second value is a measured value or a quantized value.

9. The method of claim 1, wherein the first beam quality information comprises a first measured value of a beam quality, and
wherein the first measured value is in mW unit, or
wherein the first measured value is in dBm unit.

10. The method of claim 9, further comprising:
determining a second measured value of the second beam quality information based on the first measured value and the angle information; and
determining a quantized value of the second measured value, and wherein the report comprises the quantized value of the second measured value.

11. The method of claim 10, wherein determining the quantized value of the second measured value comprises:
determining the quantized value by quantizing the second measured value to a first number of bits value in a predefined range with a first step size.

12. The method of claim 10, wherein determining the quantized value of the second measured value comprises:
determining the quantized value by quantizing the second measured value to a second number of bits value, and
the quantized value is determined with a second step size with a reference to the first measured value.

13. The method of claim 10, wherein if the angle information is associated with a predefined angle, the quantized value of the second measured value is set to an invalid value.

14. The method of claim 10, wherein if the first measured value is in dBm unit, the quantized value of the second measured value is determined based on a first mapping table, and
wherein if the first measured value is in mW unit, the quantized value of the second measured value is determined based on a second mapping table.

15. The method of claim 1, wherein the first beam quality information comprises a first quantized value of a beam quality.

16. The method of claim 15, further comprising:
determining a real value of the second beam quality information based on the first quantized value and the angle information; and
determining a second quantized value of the real value based on a predefined round rule, wherein the report comprises the second quantized value.

17. The method of claim 1, further comprising:
determining a circular value type associated with the second beam quality information based on a predefined condition, and
wherein the predefined condition is based on at least one of:
an angle value associated with the angle information, or
a circular value associated with the angle information.

18. The method of claim 17, wherein the predefined condition comprises at least one of:
if an absolute value of an angle associated with the angle information is between 0 and 45 degree or between 135 and 180 degree, the circular value type associated with the second beam quality information is sine value,
if the absolute value is between 45 and 135 degree, the circular value type associated with the second beam quality information is cosine value,
if the angle is 0 or 180 degree, the circular value type associated with the second beam quality information is cosine value,
if the angle is 90 degree, the circular value type associated with the second beam quality information is sine value,
if a first absolute value of a sine value of the angle is not larger than a second absolute value of a cosine value of the angle, the circular value type associated with the second beam quality information is sine value,
if the first absolute value of the sine value of the angle is larger than the second absolute value of the cosine value of the angle, the circular value type associated with the second beam quality information is cosine value,
if an absolute value of an angle associated with the angle information is between 0 and 45 degree or between 135 and 180 degree, the circular value type associated with the second beam quality information is cosine value,
if the absolute value is between 45 and 135 degree, the circular value type associated with the second beam quality information is sine value,
if the angle is 0 or 180 degree, the circular value type associated with the second beam quality information is sine value,
if the angle is 90 degree, the circular value type associated with the second beam quality information is cosine value,
if a first absolute value of a cosine value of the angle is not smaller than a second absolute value of a sine value of the angle, the circular value type associated with the second beam quality information is cosine value, or
if the first absolute value of the cosine value of the angle is smaller than the second absolute value of the sine value of the angle, the circular value type associated with the second beam quality information is since value.

19. The method of any of claims 1-18 wherein the report also comprises at least one of:
the first beam quality information,
the angle information,
first information that indicates whether the angle information is positive or negative, or
second information that indicates a circular value type associated with the second beam quality information.

20. A communication method, comprising:
receiving, at a network device and from a terminal device, a report that at least comprises second beam quality information, wherein the second beam quality information is determined based on first beam quality information and angle information associated with the terminal device, and wherein the first beam quality information is determined based on a set of beam qualities of a set of beams.

21. A terminal device comprising:
at least one processor; and
at least one memory coupled to the at least one processor and storing instructions thereon, the instructions, when executed by the at least one processor, causing the terminal device to perform the method according to any of claims 1-19.

22. A network device comprising:
at least one processor; and
at least one memory coupled to the at least one processor and storing instructions thereon, the instructions, when executed by the at least one processor, causing the network device to perform the method according to claim 20.

23. A computer readable medium having instructions stored thereon, the instructions, when executed on at least one processor, causing the at least one processor to perform the method according to any of claims 1-19 or claim 20.
